(19) United States
(12) Patent Application Publication
(10) Pub. No.: US 2016/0370461 A1
(43) Pub. Date: Dec. 22, 2016

(54) OPTICAL SENSOR

(71) Applicant: DENSO CORPORATION, Kariya-city, Aichi-pref (JP)

(72) Inventors: Makiko SUGIURA, Kariya-city (JP); Takahiko YOSHIDA, Kariya-city (JP); Katsunori MICHIYAMA, Kariya-city (JP)

(21) Appl. No.: 15/104,278

(22) PCT Filed: Jan. 8, 2015
(86) PCT No.: PCT/JP2015/000068

§ 371 Date: Jun. 14, 2016

(30) Foreign Application Priority Data
Jan. 10, 2014 (JP) 2014-003706
Dec. 15, 2014 (JP) 2014-253385

(51) Int. Cl. G01S 7/481; G01S 17/08; G01N 21/552

(52) U.S. Cl. CPC G01S 7/4817; G01N 21/552; G01S 17/08; G01N 2201/0612; B60S 1/0833

(57) ABSTRACT

An optical sensor includes a light-emission unit, a controller, a light-reception unit that receives a first reflected light which is reflected at the transparent plate and a second reflected light that is reflected at an external object outside of the transparent plate, a calculator that, based on the light received by the light-reception unit, calculates whether an adhered substance is adhered to the transparent plate, and calculates a relative position of the external object, and a fixing portion that fixes the light-emission unit and the light-reception unit with respect to the transparent plate, wherein the calculator calculates whether the adhered substance is adhered to the transparent plate and calculates the relative position of the external object based on the light received by the light-reception unit.

### CROSS-REFERENCE TO RELATED APPLICATIONS

The present application is based on Japanese patent application No. 2014-3706 filed on Jan. 10, 2014 and Japanese patent application No. 2014-253385 filed on Dec. 15, 2014, the content of which is incorporated herein by reference.

### TECHNICAL FIELD

The present disclosure relates to an optical sensor including a light-emission unit, a control unit that controls the light-emission unit, and a light-reception unit that receives reflected light.

### BACKGROUND ART

Conventionally, for example as disclosed in Patent Literature 1, a raindrop sensor is provided for measuring the amount of raindrops adhering to an external surface of a vehicle glass by measuring the amount of light reflected at the external glass surface. The raindrop sensor includes an infrared-emitting LED, a first light-reception element, and a second light-reception element. The infrared-emitting LED is mounted at a position such that light is totally reflected at the external surface of the vehicle glass. The first light-reception element is mounted at a position to receive the totally reflected light from the external surface of the vehicle glass, and the second light-reception element is an external light sensor.

### PRIOR ART LITERATURE

### Patent Literature

Patent Literature 1: JP 2006-29807 A

### SUMMARY OF THE INVENTION

However, according to considerations by the inventors of the present disclosure, the raindrop sensor disclosed in the above described Patent Literature 1 includes the first light-reception element for detecting raindrops and the second light-reception element for detecting external light. If light-reception elements corresponding to detection goals are included in this manner, then as many light-reception elements (light-reception units) as the number of detection goals are required. For this reason, there is a concern that the physical size of the raindrop sensor (optical sensor) may be increased.

In view of the above point, it is an object of the present disclosure to provide an optical sensor that suppresses its physical size from increasing.

According to a first disclosure, an optical sensor includes a light-emission unit that irradiates light to an inner surface of a transparent plate, a controller that controls light-emission of the light-emission unit, a light-reception unit that receives each of a first reflected light which is reflected at an interface between an outer surface of the transparent plate and external atmosphere, and a second reflected light that passes through the transparent plate and which is reflected at an external object outside of the transparent plate, a calculator that, based on the light received by the light-reception unit, performs each of calculating whether an adhered substance is adhering to the outer surface of the transparent plate, and calculating a relative position between the external object and the light-reception unit, and a fixing portion that fixes each of the light-emission unit and the light-reception unit with respect to the transparent plate, wherein the calculator calculates whether the adhered substance is adhered to the outer surface of the transparent plate based on the light received by the light-reception unit upon a time required for the light-reception unit to receive the first reflected light elapsing after the light-emission unit emits light, and calculates the relative position between the external object and the light-reception unit based on the light received by the light-reception unit at a timing other than upon the time required for the light-reception unit to receive the first reflected light elapsing after the light-emission unit emits light.

According to the first disclosure, the light-emission unit and the light-reception unit are fixed with respect to the transparent plate by the fixing portion. For this reason, the path of the first reflected light (the distance travelled by the light) reflected at the transparent plate is uniformly fixed, and the timing of when the first reflected light enters the light-reception unit is uniformly fixed. In contrast, the relative position of the external object to the optical sensor is uncertain, so the path of the second reflected light is not uniformly fixed, and the timing of when the second reflected light enters the light-reception unit is not uniformly fixed. In this regard, as described above, the calculator calculates whether an adhered substance is adhered to the outer surface of the transparent plate based on light received at the light-reception unit at the timing of the amount of time required for the light-reception unit to receive the first reflected light elapsing after the light-emission unit emits light. Further, the calculator calculates the relative position between the external object and the light-reception unit (optical sensor) based on light received at the light-reception unit at a timing other than the above described timing. Accordingly, even if the light-reception unit is commonly used for both detecting an adhered substance and detecting the relative position of the external object as described above, the two may be distinctly detected. Further, since one light-reception unit is used for detecting an adhered substance and detecting the relative position of the external object, the physical size of the optical sensor may be suppressed from increasing as compared to a case including corresponding light-reception units for each detection.

In a second disclosure, an angle of incidence mirror that controls an angle of incidence to the transparent plate for the light emitted by the light-emission unit in order to obtain the first reflected light and the second reflected light is included, wherein the angle of incidence mirror includes a reflection portion that reflects the light emitted from the light-emission unit into the transparent plate, and an angle controller that changes an angle of the reflection portion to change the angle of incidence of the light of the light-emission unit which is reflected at the reflection portion and enters the transparent plate, the controller causes the light-emission unit to emit light at fixed intervals, and the angle controller gradually changes the angle of the reflection portion in synchronization with the light-emission intervals of the light-emission unit.

According to the second disclosure, even if the directionality of the light-emission unit is strong and thus not suitable for detecting adhered substances, a suitable light for detecting adhered substances may be obtained by using the angle of incidence mirror to gradually change the angle of incidence of the light entering the transparent plate. Furthermore, the relative position between the external object and the optical lens is determined by direction and distance. The distance is obtained from the light-emission timing of the light-emission unit and the light-reception timing of the second reflected light, and the direction is obtained from the angle of incidence of the light entering the transparent plate. According to the above described configuration, the angle of incidence of the light is set by the angle controller, thus the direction may be obtained from the value of the angle of incidence controlled by the angle controller.

In a third disclosure, the calculator determines that the adhered substance is adhering to the transparent plate when the angle controller controls the reflection portion such that the second reflected light enters the light-reception unit and the light-reception unit receives light upon the time required for the light-reception unit to receive the first reflected light elapsing after the light-emission unit emits light.

When the angle controller controls the angle of the reflection portion such that the second reflected light enters the light-reception unit, light emitted from the light-emission unit is expected to pass through the transparent plate and be reflected at the external object. Accordingly, it is expected that the light-reception unit receives the reflected light at a timing after the light-emission unit emitting light and then the amount of time required for the light-reception unit to receive the first reflected light elapsing. If the light-reception unit nevertheless receives light upon the time required for the light-reception unit to receive the first reflected light elapsing after the light-emission unit emits light, it is considered that an adhered substance is adhering to the transparent plate. Accordingly, if the light-reception unit receives light at the above described timing, it may be determined that rubbish is adhering to the transparent plate.

### BRIEF DESCRIPTION OF THE DRAWINGS

FIG. 1 is a cross sectional view showing an outline configuration of an optical sensor according to a first embodiment.

FIG. 2 is a top view showing an outline configuration of an angle of incidence mirror.

FIG. 3 is a top view showing an outline configuration of a light-reception unit.

FIG. 4 is a timing chart showing each of light-emission and light-reception timings.

FIG. 5 is a timing chart for explaining a detection of rubbish.

FIG. 6 is a timing chart showing light-emission in a modified example.

FIG. 7 is a timing chart showing light-emission in a modified example.

FIG. 8 is a timing chart showing light-emission in a modified example.

FIG. 9 is a timing chart for explaining a detection of rubbish.

FIG. 10 is a cross sectional view showing an optical sensor of a modified example.

FIG. 11 is a timing chart showing each of light-emission and light-reception timings.

FIG. 12 is a timing chart for explaining a detection of rubbish.

### EMBODIMENTS FOR CARRYING OUT INVENTION

Next, embodiments of the present disclosure will be explained with reference to the figures.

### First Embodiment

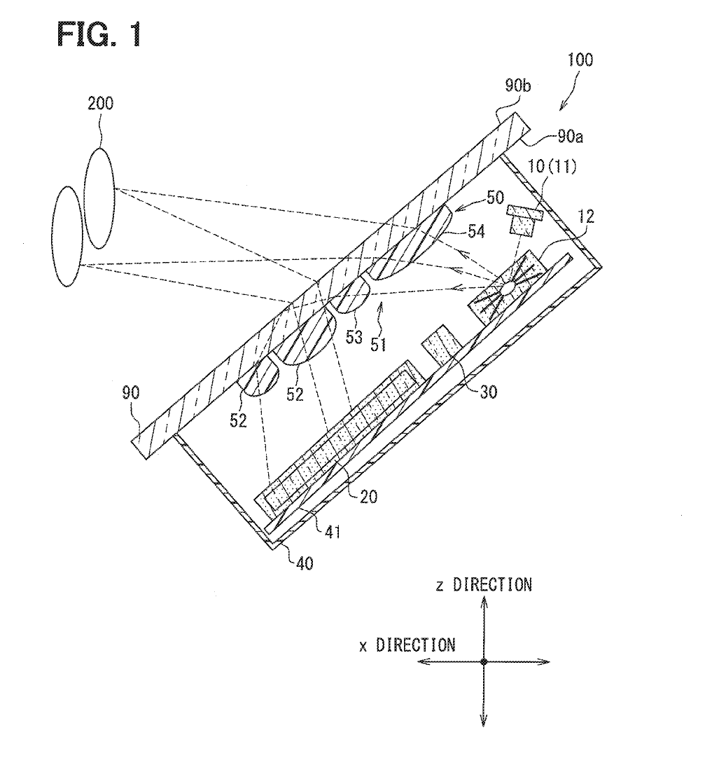

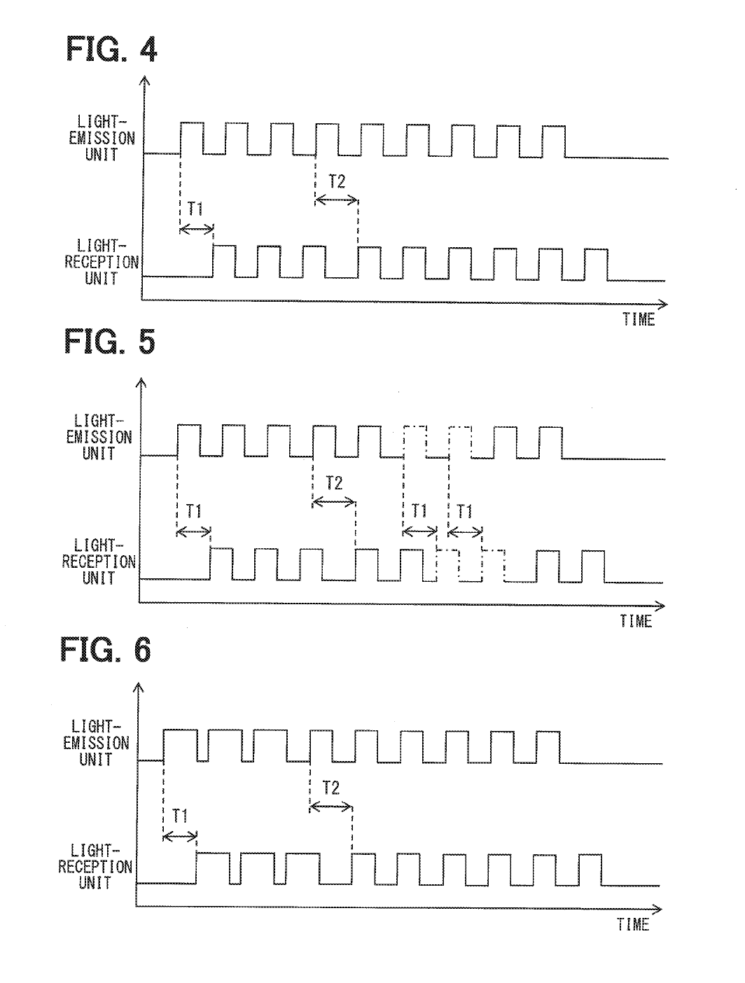

An optical sensor according to the present embodiment will be explained with reference to FIGS. 1 to 5. In FIG. 1, light is shown by the dashed lines. In FIGS. 4 and 5, the vertical axis shows voltage level, and the horizontal axis shows time. Below, the x direction, the y direction, and the z direction represent three mutually orthogonal directions. In the present embodiment, the z direction is parallel to the vertical direction, while the x and y directions define an x-y plane which is parallel to the horizontal direction. In addition, the x direction is parallel to the forward-backward direction of a vehicle, while the y direction is parallel to the left-right direction of the vehicle.

As shown in FIG. 1, an optical sensor 100 includes a light-emission unit 10, a light-reception unit 20, a processor 30, a fixing portion 40, and an optical lens 50. The light-emission unit 10, the light-reception unit 20, and the processor 30 are each fixed by the fixing portion 40 to an inner surface 90a of a transparent plate 90. The optical lens 50 is fixed to the inner surface 90a through a transparent fastener sheet (not illustrated). The transparent plate 90 may be, for example, the windshield of a vehicle. The optical sensor 100 detects adhered substances such as water adhering to the transparent plate 90, and/or detects the position of an external object 200 outside of the vehicle.

As shown by the dashed lines in FIG. 1, light emitted from the light-emission unit 10 enters the transparent plate 90 through the optical lens 50. After entering the transparent plate 90, the light enters an interface between an outer surface 90b of the transparent plate 90 and the external atmosphere (hereinafter, simply referred to as an “interface”) at various angles. If the angle of incidence of the light, which is defined as the angle between the travel direction of the light and a perpendicular line orthogonal with respect to the interface (i.e., the outer surface 90b), is equal to or greater than 42°, then all of the light is totally reflected at the interface. However, if the angle of incidence is less than 42°, a portion of the light is not reflected, passes through the transparent plate 90, and continues outside. Then, the light is reflected at the external object 200 positioned outside of the transparent plate 90, and a portion thereof returns to the transparent plate 90. Both the light which is totally reflected at the interface (hereinafter, referred to as a “first reflected light”) and the light reflected at the external object 200 and returned to the transparent plate 90 (hereinafter, referred to as a “second reflected light”) pass through the transparent plate 90 and the optical lens 50 and then enter the light-reception unit 20.

If an adhered substance such as water is adhered to the outer surface 90b of the transparent plate 90, even light having an angle of incidence of 42° or greater is not reflected at the interface, and instead passes through the transparent plate 90. As a result, the amount of the first reflected light entering the light-reception unit 20 is reduced. Accordingly, the processor 30 detects whether adhered substances exist based on a reduced state of the first reflected light. In addition, the timing of when the second reflected light enters the light-reception unit 20 depends on the relative positions of the optical sensor 100 and the external object 200. Accordingly, the processor 30 detects the relative positions of the optical sensor 100 and the external object 200 based on when the second reflected light enters the light-reception unit 20.

The light-emission unit 10 is configured to irradiate light to the inner surface 90a of the transparent plate 90. The light-emission unit 10 of the present embodiment includes an LD (laser diode) 11 which has greater directionality than LEDs (light-emitting diodes). An LD 11 with a wavelength region in the degree of 800 to 900 nm is used.

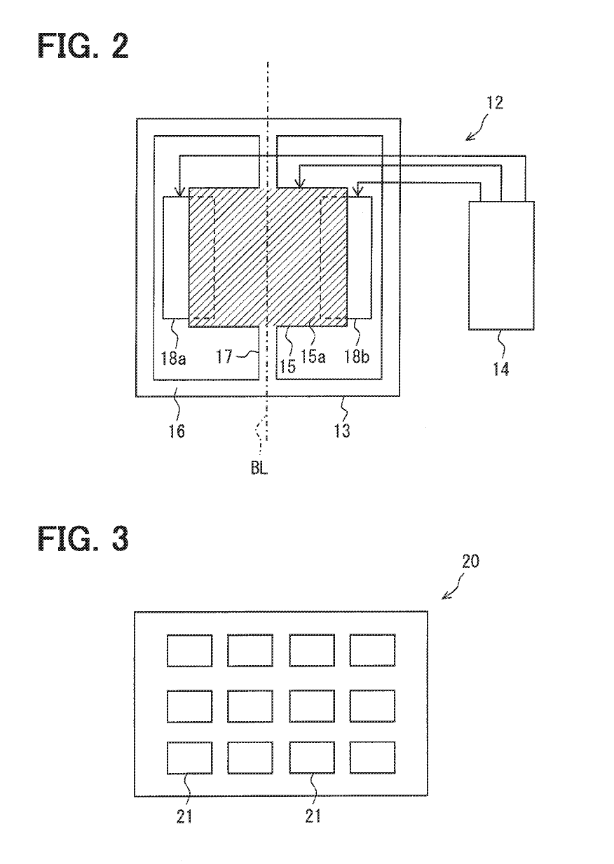

To obtain the above described first reflected light and second reflected light, the optical sensor 100 includes an angle of incidence mirror 12 that controls the angle of incidence of laser light, which is generated at the LD 11, toward the transparent plate 90.As shown in FIG. 2, the angle of incidence mirror 12 includes a reflection portion 13 and an angle controller 14. The reflection portion 13 reflects the laser light, which is irradiated from the LD 11, toward the transparent plate 90. The angle controller 14 changes the angle of the reflection portion 13 with respect to the travel direction of the laser light, thereby changing the interface angle of incidence of the laser light entering the transparent plate 90.

The angle of incidence mirror 12 is a so-called MEMS mirror, and the reflection portion 13 is formed by microfabricating an SOI substrate. The reflection portion 13 includes a mirror surface portion 15, a support portion 16, coupling portions 17, and electrodes 18a, 18b. The mirror surface portion 15 reflects the laser light, and the support portion 16 supports the mirror surface portion 15. In addition, the coupling portions 17 couple the support portion 16 to the mirror surface portion 15. The electrodes 18a, 18b adjust the reflection angle of the mirror surface portion 15 with respect to the laser light. The support portion 16 is frame shaped, and the mirror surface portion 15 is positioned in a region surrounded by the support portion 16. In FIG. 2, the mirror surface portion 15 is shown by hatching, and a top surface 15a of the mirror surface portion 15 reflects light. Each of two corresponding side surfaces of the mirror surface portion 15 is coupled to one end of the coupling portions 17, which the other end of the coupling portions 17 is coupled to the inner ring surface of the support portion 16. Then, each of the two coupling portions 17 is formed to extend along a reference line BL (shown as a dashed line in FIG. 2) that passes through the centroid of the mirror surface portion 15.

Due to this, the mirror surface portion 15 is rotatable about the reference line BL, with the part along the reference line BL acting as a rotation axis. Each of the electrodes 18a, 18b is positioned below the mirror surface portion 15, and face a portion of the lower surface of the mirror surface portion 15. To be specific, A first electrode 18a faces a portion of the lower surface of one of the two halves of the mirror surface portion 15 as divided by the reference line BL, while a second electrode 18b faces a portion of the lower surface of the other half of the mirror surface portion 15. Due to this configuration, the angle controller 14 may applied a fixed voltage to the mirror surface portion 15 and apply voltages of opposite polarity to each of the electrodes 18a, 18b to generate an electrostatic attractive force at the mirror surface portion 15 that causes the mirror surface portion 15 to rotate in one direction. According to the present embodiment, the surface areas of the electrodes 18a, 18b which face the mirror surface portion 15 are equal to each other.

The LD 11 emits light at fixed time intervals. The angle controller 14 gradually raises the voltage levels of the electric signals applied to each of the electrodes 18a, 18b in synchronization with the light-emission intervals of the LD 11. Accordingly, laser light is irradiated into the transparent plate 90 in a pulsed manner, and the angle of incidence of each light pulse entering the transparent plate 90 is gradually changed. The angle controller 14 of the present embodiment controls the rotation angle of the mirror surface portion 15 such that the second reflected light is obtained after the first reflected light is obtained.

More specifically, the angle controller 14 controls the rotation angle of the mirror surface portion 15 such that the angle of incidence of the light toward the interface changes from an angle greater than 42° to an angle less than 42°. Accordingly, the light-reception unit 20 receives the first reflected light at a first timing and the light-reception unit 20 receives the second reflected light at a second timing, the first timing being earlier than the second timing. In the present embodiment, the angle controller 14 controls the angle of incidence of the light toward the interface to incrementally change from 45° to 15°. In this manner, the angle of incidence includes a greater number of angles under 42° than angles over 42°. Thus, the irradiation range of light passing through the transparent plate 90 is broadened, and the detection range of the external object 200 is broadened.

The light-reception unit 20 receives both the first reflected light and the second reflected light. As shown in FIG. 3, the light-reception unit 20 includes a plurality of light-reception elements 21 disposed side by side in a matrix configuration. The light-reception elements 21 are photoelectric converter elements that convert light into an electric signal, or photodiodes to be specific.

The processor 30 includes both the functions of the controller and the calculator recited in the scope of the claims. In other words, the processor 30 controls the light-emission unit 10 to emit light, calculates whether an adhered substance (water) is adhered to the outer surface 90b of the transparent plate 90, and also calculates the relative positions of the external object 200 and the optical sensor 100.

The processor 30 is synchronized with the angle controller 14, and causes the light-emission unit 10 (the LD 11) to repeatedly emit single bursts of light with a fixed time interval. The timing of when reflected light returns to the light-reception unit 20 is based on the speed of light, and therefore is sufficiently faster than a light-emission control time required between emitting one burst of light and emitting the subsequent burst of light (i.e., the above described fixed time interval). Accordingly, after the processor 30 causes the LD 11 to emit a single burst of light, the reflected light is received by the light-reception unit 20 before the LD 11 emits the next burst of light. In addition, each time the processor 30 causes the LD 11 to emit light, the angle controller 14 adjusts the reflection angle of the reflection portion 13 by 1°. Due to this, pulsed laser light having different angles of incidence to the transparent plate 90 enters the transparent plate 90 in turn.

As described above, the angle controller 14 controls the rotation angle of the mirror surface portion 15 such that the angle of incidence of light toward the interface changes from an angle greater than 42° to an angle less than 42°. Accordingly, as shown in FIG. 4, after the light-emission unit 10 emits light, an amount of time required for the light-reception unit 20 to receive the first reflected light (hereinafter, referred to as a “first reflection time T1”) elapses, and then the first reflected light enters the light-reception unit 20. Conversely, after the light-emission unit 10 emits light, an amount of time greater than the first reflection time T1 elapses, and then the second reflected light enters the light-reception unit 20. This is because, with respect to the amount of time required for the light-reception unit 20 to receive the second reflected light (hereinafter, referred to as a “second reflection time T2”) after the light-emission unit 10 emit light, the external object 200 is positioned further from the light-reception unit 20 than the transparent plate 90 is to the light-reception unit 20.

In addition, although the second reflection time T2 is longer than the first reflection time T1, the value of the second reflection time T2 changes according to the relative position between the external object 200 and the optical sensor 100. Accordingly, the processor 30 calculates whether an adhered substance is adhered to the outer surface 90b of the transparent plate 90 based on the light received by the light-reception unit 20 upon the first reflection time T1 elapsing after the light-emission unit 10 emits light. In addition, at a different timing than that, the processor 30 calculates the relative position between the external object 200 and the optical sensor 100 based on the light received by the light-reception unit 20.

In addition, the first reflection time T1 depends on each of the distance between the light-emission unit 10 and the transparent plate 90 and the distance between the transparent plate 90 and the light-reception unit 20. These distances are on the order of several tens of centimeters. In contrast, the second reflection time T2 depends on each of the distance between the light-emission unit 10 and the external object and the distance between the external object 200 and the light-reception unit 20. These distances are anticipated to be on the order of about several tens to several hundreds of meters. Accordingly, there is a difference of about 100 to 1000 times between the first reflection time T1 and the second reflection time T2. Since both reflection times T1, T2 are based on the speed of light, their values are microscopic. However, since there is a difference of about 100 to 1000 times between the two values as described above, the two values may be clearly distinguished from each other.

As described above, the light-reception unit 20 includes the plurality of light-reception elements 21 disposed side by side in a matrix configuration. The light irradiated onto the external object 200 is dispersed at the surface thereof, so the directionality of the second reflected light is reduced, and the second reflected light enters the light-reception unit 20 with a degree of spreading. Accordingly, in order to receive the second reflected light with this spread, the plurality of light-reception elements 21 are disposed side by side in a matrix configuration as described above.

In addition, the processor 30 records, one by one, the light-emission timings of the light-emission unit 10 and the angles allocated by the angle controller 14. The processor 30 obtains the second reflection time T2 from the light-emission timing of light having an angle of incidence less than 42° (i.e., light that passes through the transparent plate 90) and the light-reception timing of that light, and based on the second reflection time T2, calculates the relative distance between the external object 200 and the optical sensor 100. In addition, the processor 30 calculates the direction of the external object 200 from the angle allocated by the angle controller 14. In this manner, the processor 30 calculates the distance and direction of the external object 200 to detect the position of the external object 200.

As shown in FIG. 4, when the angle controller 14 controls the angle of the reflection portion 13 such that the first reflected light enters the light-reception unit 20, it is expected that the first reflected light will be received upon the first reflection time T1 elapsing after the light-emission unit 10 emits the light. Further, when the angle controller 14 controls the angle of the reflection portion 13 such that the second reflected light enters the light-reception unit 20, it is expected that the second reflected light will be received upon the second reflection time T2, which is longer than the first reflection time T1, elapsing after the light-emission unit 10 emits the light.

It should be noted that even when the angle controller 14 controls the angle of the reflection portion 13 such that the second reflected light enters the light-reception unit 20, a portion of the light is reflected at the outer surface 90b of the transparent plate 90, and faint light enters the light-reception unit 20. However, as shown by the one-dot-one-dash line in FIG. 5, when the angle controller 14 controls the angle of the reflection portion 13 such that the second reflected light enters the light-reception unit 20, stronger light is occasionally received upon the first reflection time T1 elapsing after the light-emission unit 10 emits the light. This is expected when rubbish, adhered to the transparent plate 90, scatters or reflects light which then enters the light-reception unit 20.

Here, the processor 30 determines that rubbish is adhering to the transparent plate 90 when the angle controller 14 controls the angle of the reflection portion 13 such that the second reflected light enters the light-reception unit 20 but light is received by the light-reception unit 20 at a timing of the first reflection time T1 elapsing after the light-emission unit 10 emits light. In addition, to simplify the explanation, FIG. 4 shows a case where all of the light passing through the transparent plate 90 is reflected at the external object 200, and the second reflected light enters the light-reception unit 20 at the second reflection time T2.

The fixing portion 40 fixes each of the light-emission unit 10 and the light-reception unit 20 with respect to the transparent plate 90. In the present embodiment as shown in FIG. 1, each of the light-emission unit 10, the light-reception unit 20, and the processor 30 are fixed to a wiring substrate 41. The fixing portion 40 then fixes this wiring substrate 41 to the transparent plate 90, thereby fixing each of the light-emission unit 10 and the light-reception unit 20 to the transparent plate 90. The fixing portion 40 according to the present embodiment has a closed-bottom cylindrical shape, with its one opening portion being closed by the inner surface 90a of the transparent plate 90. A housing space is defined as the regions of the fixing portion 40 and the inner surface 90a which are surrounded by the opening portion of the fixing portion 40, and the wiring substrate 41 is housed in this housing space. In addition, the optical lens 50 is also housed in the above described housing space, and similarly the fixing portion 40 fixes the optical lens 50 to the inner surface 90a through an adhesive sheet (not illustrated).

The optical lens 50 includes a light guiding lens 51 and a light collecting lens 52. The light guiding lens 51 guides light emitted from the light-emission unit 10 to the transparent plate 90. The light collecting lens 52 collects the first reflected light and the second reflected light into the light-reception unit 20. The light guiding lens 51 includes a first lens 53 and a second lens 54. The first lens 53 has a function of uniformly aligning the angle of incidence toward the transparent plate 90 in order to cause the light emitted from the light-emission unit 10 to be fully reflected at the interface to obtain the first reflected light. In contrast, the second lens 54 has a function of spreading out of the range of angle of incidence toward the transparent plate 90 in order to cause the light emitted from the light-emission unit 10 to transmit through the transparent plate 90 to obtain the second reflected light. In the present embodiment, the light guiding lens 51 and the light collecting lens 52 are formed separately from each other, but they may be formed from the same component as well.

Next, the operation effect of the optical sensor 100 according to the present embodiment will be explained. As described above, the light-emission unit 10 (LD 11) and the light-reception unit 20 are fixed with respect to the transparent plate 90 by the fixing portion 40. For this reason, the path of the first reflected light (the distance travelled by the light) reflected at the transparent plate 90 is uniformly fixed, and the timing of when the first reflected light enters the light-reception unit 20 is uniformly fixed. In contrast, the relative position of the external object 200 to the optical sensor 100 is uncertain, so the path of the second reflected light is not uniformly fixed, and the timing of when the second reflected light enters the light-reception unit 20 is not uniformly fixed.

In this regard, as described above, the processor 30 calculates whether an adhered substance (e.g., raindrops) is adhered to the outer surface 90b of the transparent plate 90 based on light received at the light-reception unit 20 at the timing of the amount of time required for the light-reception unit 20 to receive the first reflected light (the first reflection time T1) elapsing after the light-emission unit 10 emits light. Further, the processor 30 calculates the relative position between the external object 200 and the optical sensor 100 based on light received at the light-reception unit 20 at a timing other than the above described timing. Accordingly, even if the light-reception unit 20 is commonly used for both detecting an adhered substance and detecting the relative position of the external object 200 as described above, the two may be distinctly detected. Further, since one light-reception unit 20 is used for detecting an adhered substance and detecting the relative position of the external object 200, the physical size of the optical sensor 100 may be suppressed from increasing as compared to a configuration including corresponding light-reception units 20 for each detection.

The angle of incidence mirror 12 is provided to control the angle of incidence of the laser light emitted by the LD 11 toward the transparent plate 90, and the angle of incidence mirror 12 guides the laser light into the transparent plate 90 with gradually differing angles of incidence toward the transparent plate 90.

Accordingly, even if the directionality of the light-emission unit 10 is strong and thus not suitable for detecting adhered substances, a suitable light for detecting adhered substances may be obtained by using the angle of incidence mirror 12 to gradually change the angle of incidence of the light entering the transparent plate 90. Furthermore, the relative position between the external object 200 and the optical sensor 100 is determined by direction and distance. The distance is obtained from the second reflection time T2, and the direction is obtained from the angle of incidence of the light entering the transparent plate 90. According to the above described configuration, the angle of incidence of the light is set by the angle controller 14, thus the direction may be obtained from the value of the angle of incidence controlled by the angle controller 14.

The processor 30 determines that rubbish is adhering to the transparent plate 90 when the angle controller 14 controls the angle of the reflection portion 13 such that the second reflected light enters the light-reception unit 20 but light is received by the light-reception unit 20 at a timing of the first reflection time T1 elapsing after the light-emission unit 10 emits light. When the angle controller 14 controls the angle of the reflection portion 13 such that the second reflected light enters the light-reception unit 20, light emitted from the light-emission unit 10 is expected to pass through the transparent plate 90 and be reflected at the external object 200. Accordingly, it is expected that the light-reception unit 20 receives the reflected light at a timing after the light-emission unit 10 emitting light and then the amount of time required for the light-reception unit 20 to receive the first reflected light (the first reflection time T1) elapsing. If the light-reception unit 20 nevertheless receives light at the above described timing, it is considered that rubbish is adhered to the transparent plate 90. Accordingly, if the light-reception unit 20 receives light at the above described timing, it may be determined that rubbish is adhering to the transparent plate 90.

The light guiding lens 51 includes the first lens 53 and the second lens 54. The first lens 53 has a function of uniformly aligning the angle of incidence toward the transparent plate 90 in order to cause the light emitted from the light-emission unit 10 to be fully reflected at the interface between the transparent plate 90 and the external atmosphere to obtain the first reflected light. The second lens 54 has a function of spreading out of the range of angle of incidence toward the transparent plate 90 in order to cause the light emitted from the light-emission unit 10 to transmit through the transparent plate 90 to obtain the second reflected light. Accordingly, regardless of the directionality of the light-emission unit 10, it is possible to use the light guiding lens 51 to adjust the amount of light of each of the first reflected light and the second reflected light.

The light-reception unit 20 includes the plurality of light-reception elements 21 disposed side by side in a matrix configuration. Accordingly, the second reflected light, which is dispersed by the external object 200 and has a degree of spread, may be detected by the plurality of light-reception elements 21.

Above, a preferred embodiment of the present disclosure is explained, but the present disclosure is not limited to the above described embodiment. A variety of modified embodiments, which do not depart from the gist of the present disclosure, are contemplated.

### MODIFIED EXAMPLE 1

The present embodiment is directed toward an example in which the processor 30 causes the LD 11 to emit light at fixed time intervals and causes the angle controller 14 to adjust the reflection angle of the reflection portion 13 in synchronization with the light-emission interval of the LD 11, thereby causing pulses of laser light (hereinafter, “pulse light”) having different angles of incidence to enter the transparent plate 90. Then, as shown in the example of FIGS. 4 and 5, both the voltage application time (light-emission time) and the applied voltage level (light amount) of the pulse light emitted from the LD 11 are constant. However, for example as shown in the example of FIGS. 6 to 8, the light-emission time and the light amount of the pulse light may each be changed according to the angle of incidence into the transparent plate 90.

FIG. 6 shows an example in which the light-emission time of the pulse light is longer when the angle controller 14 controls the angle of incidence of light into the interface from 45° to 42° during which total reflection occurs, than when controlling from 42° to 15°. In other words, in this example, the light-emission time of the pulse light for obtaining the first reflected light (hereinafter, referred to as a “first pulse light”) is set to be greater than the light-emission time of the pulse light for obtaining the second reflected light (hereinafter, referred to as a “second pulse light”).

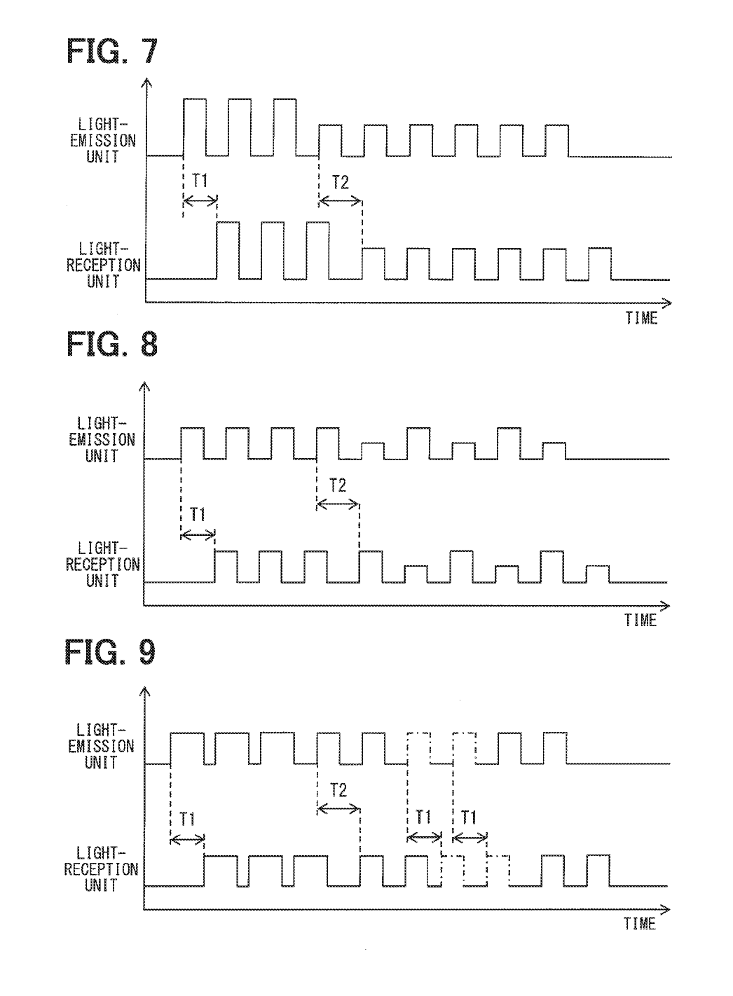

In addition, FIG. 7 shows an example where the light amount of the first pulse light is increased as compared to the light amount of the second pulse light. Further, FIG. 8 shows an example where a light-emission pattern of a plurality of light amounts of the first pulse light (a “first light-emission pattern”) is set to be different from a light-emission pattern of a plurality of light amounts of the second pulse light (a “second light-emission pattern”). According to the first light-emission pattern shown in FIG. 8, the plurality of light amounts of the first pulse light are constant, whereas in the second light-emission pattern, the plurality of light amounts of the second pulse light follow a fixed pattern. The second light-emission pattern has light amount levels of a first level and a second level, and has a pattern of alternatingly emitting the second pulse light at the first level and the second pulse light at the second level.

As described above, at least one of a light-emission time, a light amount, and a light-emission pattern differs between the first pulse light and the second pulse light. Accordingly, the processor 30 may more easily differentiate between the first reflected light and the second reflected light. For example, if the light-emission time is made different as described above, then as shown in FIG. 9, the light-reception time may be also used to detect rubbish adhering to the transparent plate 90, in addition to the reflection time. Accordingly, the detection accuracy for rubbish may be improved.

### MODIFIED EXAMPLE 2

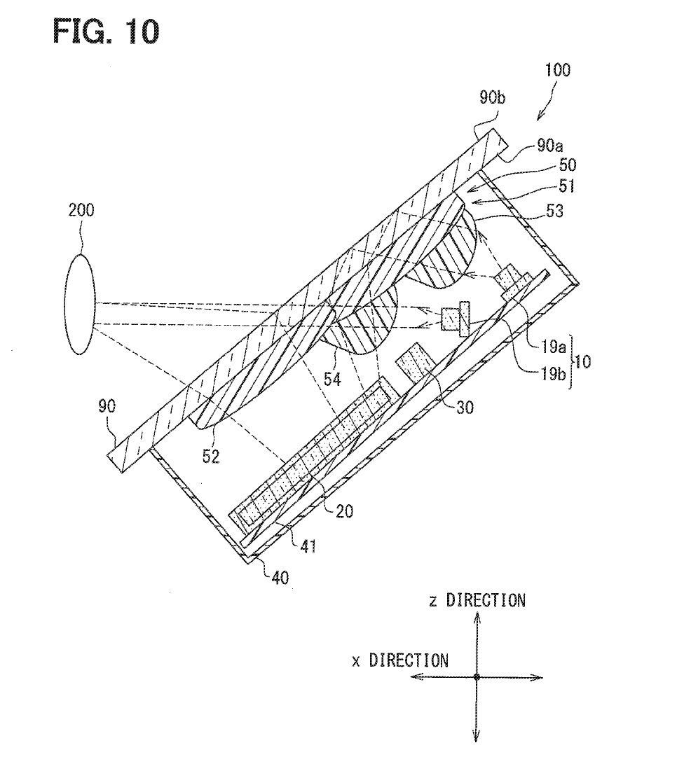

According to the present embodiment, an example is shown in which the light-emission unit 10 includes one LD 11. However, as shown in FIG. 10, a light-emission unit 10 that includes a first light-emission element 19a and a second light-emission element 19b may be used as well. The first light-emission element 19a is an LED (light emitting diode), and the second light-emission element 19b is an LD (laser diode) similar to the LD11 of the first embodiment. The first light-emission element 19a is for obtaining the first reflected light by irradiating light onto the transparent plate 90, and the second light-emission element 19b is for obtaining the second reflected light by irradiating light through the transparent plate 90 and onto the external object 200.

Light is emitted from the first light-emission element 19a with an angle of incidence at or above 42° to the interface so as to be totally reflected at the interface. Further, light is emitted from the second light-emission element 19b with an angle of incidence below 42° to the interface so as to pass through the interface. These angles of incidence are set by positioning the light-emission elements 19a, 19b with respect to the transparent plate 90 and by the light guiding lens 51.

According to this configuration, in contrast to a configuration where a light-emission unit includes one light-emission element, it is possible to selectively emit light with suitable directionality for detecting adhered substances, and emit light with suitable directionality for detecting the relative position of the external object 200.

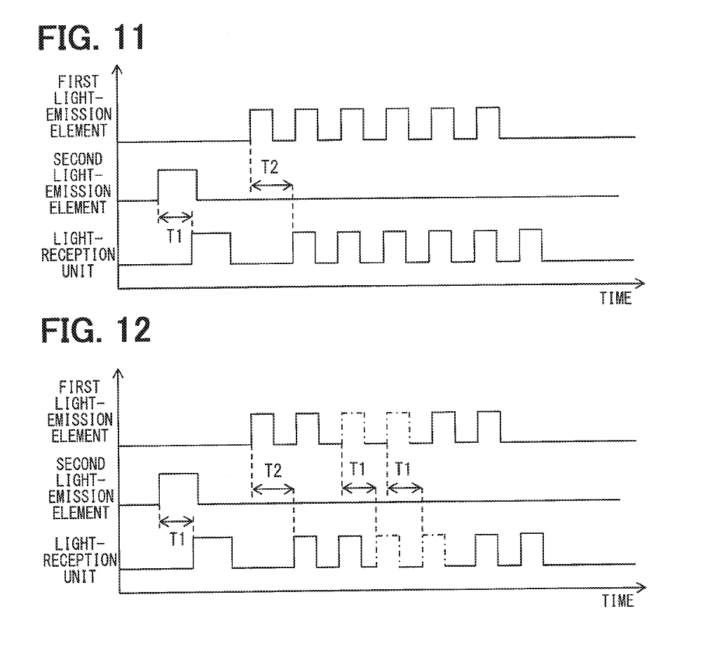

As described above, the first reflected light is reflected at the interface and then enters the light-reception unit 20, whereas the second reflected light is reflected at the external object 200 outside of the transparent plate 90 and then enters the light-reception unit 20. In this regard, the amount of distance travelled (path) of the first reflected light is shorter as compared to the second reflected light. For this reason, in the modified example shown in FIG. 10, the processor 30 causes the first light-emission element 19a to emit light, and thereafter causes the second light-emission element 19b to emit light, as shown in FIG. 11. By doing this, the first timing at which the light-reception unit 20 receives the first reflected light is set to be different from the second timing at which the light-reception unit 20 receives the second reflected light. That is, the first reflected light enters the light-reception unit 20 before the second reflected light enters the light-reception unit 20.

It is expected that the light emitted from the second light-emission element 19b passes through the transparent plate 90 and is reflected at the external object 200. Accordingly, it is expected that the light-reception unit 20 receives the light emitted from the second light-emission element 19b at a timing after the second light-emission element 19b emitting light and then the amount of time required for the light-reception unit 20 to receive the first reflected light (the first reflection time T1) elapsing. If the light-reception unit 20 nevertheless receives light at the first reflection time T1 as shown, for example, by the one-dot-one-dash line in FIG. 12, it may be considered that rubbish is adhered to the transparent plate 90. Accordingly, if the light-reception unit 20 receives light at a timing of the first reflection time T1 elapsing after the second light-emission element emitting light, the processor 30 determines that rubbish is adhering to the transparent plate 90.

In addition, if an adhered substance such as water or the like is adhered to the transparent plate 90, there is a concern that the amount of light passing through the transparent plate 90 may be scattered by raindrops, and that the detection accuracy of the relative position of the external object 200 may decrease. In this regard, when the processor 30 calculates that an adhered substance such as water or the like is adhered to the transparent plate 90, then at least one of increasing the light-emission amount of the second light-emission element 19b and narrowing the directionality of the second light-emission element 19b is performed. By doing so, it is possible to restrain a decrease in the amount of light emitted out of the transparent plate 90, and thus restrain a decrease in the detection accuracy of the relative position of the external object 200. In addition, in order to narrow the directionality as described above, the second light-emission element 19b includes variable light-concentration optics in addition to a diode laser.

Further, the processor 30 records the angles of incidence to the interface of the light emitted from the light-emission elements 19a, 19b. Accordingly, the processor 30 calculates the direction of the external object 200 from the angles of incidence to the interface of the light emitted from the second light-emission element 19b. In addition, the processor 30 obtains the second reflection time T2 using the light-emission timing of the second light-emission element 19b and the light-reception timing of that light, and based on that, calculates the relative distance between the external object 200 and the optical sensor 100. In this regard, the processor 30 calculates the distance and direction of the external object 200, and thereby detects the position of the external object 200. In addition, for the modified example shown in FIGS. 10 to 12, as an alternative, the optical sensor 100 may not include the angle of incidence mirror.

### OTHER MODIFIED EXAMPLES

The present embodiment shows an example in which the optical sensor includes the optical lens 50. However, the optical lens 50 may be not provided as well.

The present embodiment shows an example in which the transparent plate 90 is a windshield of a vehicle. However, any object to which water adheres may be suitably used as the transparent plate 90.

The present embodiment shows an example in which light is totally reflected when the angle of incidence to the interface is at or above 42°, and light passes through the interface when the angle of incidence is below 42°. However, the angle of incidence at which total reflection occurs described above (hereinafter, referred to as a “total reflection angle”) varies depending on the material forming the transparent plate 90. The present embodiment is not limited to the specifically described value for the total reflection angle. If the material forming the transparent plate 90 is changed and as a result the total reflection angle changes, then the angle of incidence to the interface is changed accordingly.

In the present embodiment, there was no specific discussion as to how to calculate a reduced state of the first reflected light. For example, a reduction in the first reflected light may be calculated by detecting the first reflected light in a state where there is no adhered substances on the outer surface 90b of the transparent plate 90, and an electrical signal corresponding to this detected first reflected light is set as a threshold value. Then, by this threshold value is compared with an electrical signal corresponding to the first reflected light detected during actual use. In this manner, a reduction state of the first reflected light may be calculated, and whether an adhered substance exists may be detected. In addition, it is possible to detect the extent to which an adhered substance is adhered to the outer surface 90b of the transparent plate 90 based on the reduction amount of the first reflected light. If, as shown in the present embodiment, the optical sensor 100 is mounted on a vehicle, wipers may be activated based on whether an adhered substance such as water exists, and the speed of the wipers may be set based on the extent to which the adhered substance is adhered.

The present embodiment shows an example in which the angle of incidence mirror 12 is a MEMS mirror. However, the angle of incidence mirror 12 is not limited to the above described example, and any type of mirror capable of gradually adjusting the angle of incidence to the interface for the light of the light-emission unit 10 may be suitable used.

The present embodiment shows an example in which the rotation angle of the reflection portion 13 is controlled through an electrostatic attractive force. However, the angle control method of the reflection portion 13 is not limited to the above described example. For instance, a magnetic force or pressure may be used to bend and control the angle of the reflection portion 13. Of course, when using these modified examples, the reflection portion 13 will have a different configuration than as shown in FIG. 2. These modified examples are well known, and so their descriptions are omitted here.

The present embodiment shows an example in which light is emitted into the transparent plate 90 in a pulsed manner. However, the shape of the light entering the transparent plate 90 is not limited to the above described example, and any shape may be suitably used for detecting the positions of adhered substances and the external object 200.

The present embodiment shows an example in which the angle of incidence of the light to the interface is changed from an angle greater than 42° to an angle less than 42°. However, the angle of incidence of the light to the interface may be changed from an angle less than 42° to an angle greater than 42° instead.

The present embodiment shows an example in which the angle of incidence of the light to the interface is controlled from 45° to 15° in increments of 1°. However, the range of the angle of incidence is not limited to the above described example, and the value of the increment is not limited to the above described example. Any range and incremental value suitable for detecting the positions of adhered substances and the external object 200 may be used as appropriate.

The present embodiment shows an example in which the light-reception unit 20 includes the plurality of light-reception elements 21 disposed side by side in a matrix configuration. However, the light-reception unit 20 is not limited to the above described example, and may be formed of one light-reception element 21 as well.

The present embodiment shows an example in which the processor 30 combines the functions of the controller and the calculator recited in the scope of the claims. However, the processor 30 may not the functions of the controller and the calculator recited in the scope of the claims as well. In other words, the controller and the calculator may be separately formed.

The present embodiment shows an example in which the processor 30 considers the external object 200 to have a particular shape in order to approximate the direction of the external object 200 based on the position of the light-reception element 21 which receives the second reflected light. This particular shape may be a sphere, a cube, and the like. However, if the external object 200 is specified to be a guard rail, for example, the processor 30 may approximate the direction of the external object 200 based on the specified shape of the external object 200 and the position of the light-reception element 21 which receives the second reflected light from that shape. Further, as shown in FIG. 8, when the second light-emission pattern is set to alternately output pulse light at a first level and pulse light at a second level, it is possible to detect whether the outer surface shape of the external object 200 is uniform based on whether the received light has the same pattern.

The present embodiment shows an example in which each of the light-emission unit 10, the light-reception unit 20, and the processor 30 is fixed to the wiring substrate 41. However, each of the light-emission unit 10, the light-reception unit 20, and the processor 30 is not necessarily fixed to the same wiring substrate 41.

The present embodiment shows an example in which the processor 30 are each fixed to the transparent plate 90. However, the processor 30 may be not fixed with respect to the transparent plate 90 as well. In other words, the relative position between the processor 30 and the transparent plate 90 may variable.

The present embodiment shows an example in which the fixing portion 40 has a closed-bottom cylindrical shape. However, the shape of the fixing portion 40 is not limited to the above described example, as long as each of the light-emission unit 10 and the light-reception unit 20 may be fixed to the transparent plate 90.

The present embodiment shows an example in which the fixing portion 40 is fixed to the transparent plate 90 through an adhesive sheet. However, the component used to fix the fixing portion 40 to the transparent plate 90 is not limited to the above described example.

1. An optical sensor, comprising:
a light-emission unit that irradiates light to an inner surface of a transparent plate;
a controller that controls light-emission of the light-emission unit;
a light-reception unit that receives each of
a first reflected light which is reflected at an interface between an outer surface of the transparent plate and external atmosphere, and
a second reflected light that passes through the transparent plate and which is reflected at an external object outside of the transparent plate;
a calculator that, based on the light received by the light-reception unit, performs each of
calculating whether an adhered substance is adhering to the outer surface of the transparent plate, and
calculating a relative position between the external object and the light-reception unit; and
a fixing portion that fixes each of the light-emission unit and the light-reception unit with respect to the transparent plate, wherein
the calculator
calculates whether the adhered substance is adhered to the outer surface of the transparent plate based on the light received by the light-reception unit upon a time required for the light-reception unit to receive the first reflected light elapsing after the light-emission unit emits light, and
calculates the relative position between the external object and the light-reception unit based on the light received by the light-reception unit at a timing other than upon the time required for the light-reception unit to receive the first reflected light elapsing after the light-emission unit emits light.

2. The optical sensor of claim 1, further comprising:
an angle of incidence mirror that controls an angle of incidence to the transparent plate for the light emitted by the light-emission unit in order to obtain the first reflected light and the second reflected light, wherein
the angle of incidence mirror includes
a reflection portion that reflects the light emitted from the light-emission unit into the transparent plate, and
an angle controller that changes an angle of the reflection portion to change the angle of incidence of the light of the light-emission unit which is reflected at the reflection portion and enters the transparent plate,
the controller causes the light-emission unit to emit light at fixed intervals, and
the angle controller gradually changes the angle of the reflection portion in synchronization with the light-emission intervals of the light-emission unit.

3. The optical sensor of claim 2, wherein
the calculator determines that the adhered substance is adhering to the transparent plate when the angle controller controls the reflection portion such that the second reflected light enters the light-reception unit and the light-reception unit receives light upon the time required for the light-reception unit to receive the first reflected light elapsing after the light-emission unit emits light.

4. The optical sensor of claim 2, wherein
the controller set a light-emission time for the light emitted by the light-emission unit at each of the fixed intervals for obtaining the first reflected light to be different than a light-emission time for the light emitted by the light-emission unit at each of the fixed intervals for obtaining the second reflected light.

5. The optical sensor of claim 2, wherein
the controller sets a light amount for the light emitted by the light-emission unit at each of the fixed intervals for obtaining the first reflected light to be different than a light amount for the light emitted by the light-emission unit at each of the fixed intervals for obtaining the second reflected light.

6. The optical sensor of claim 2, wherein
the controller sets a light pattern for the light emitted by the light-emission unit at the fixed intervals for obtaining the first reflected light to be different than a light pattern for the light emitted by the light-emission unit at the fixed intervals for obtaining the second reflected light.

7. The optical sensor of claim 1, wherein
the light-emission unit includes
a first light-emission element for emitting light toward the transparent plate to obtain the first reflected light, and
a second light-emission element for irradiating light through the transparent plate and onto the external object to obtain the second reflected light, and
the controller controls light-emission timings of the first light-emission element and the second light-emission element such that a first timing at which the light-reception unit receives the first reflected light is different from a second timing at which the light-reception unit receives the second reflected light.

8. The optical sensor of claim 7, wherein
the controller causes the second light-emission element to emit light after the first light-emission element emits light so that the first timing is different from the second timing and so that the first reflected light enters the light-reception unit before the second reflected light enters the light-reception unit.

9. The optical sensor of claim 7, wherein
the calculator determines that the adhered substance is adhering to the transparent plate when the light-reception unit receives light upon the time required for the light-reception unit to receive the first reflected light elapsing after the second light-emission element emits light.

10. The optical sensor of claim 7, wherein
the controller, upon the calculator calculating that the adhered substance is adhering to the outer surface of the transparent plate, performs at least one of increasing a light-emission amount of the second light-emission element and narrowing a directionality of the second light-emission element.

11. The optical sensor of claim 1, further comprising:
a light guiding lens that guides the light emitted by the light-emission unit to the transparent plate to obtain the first reflected light and the second reflected light, wherein
the light guiding lens includes
a first lens that uniformly aligns the angle of incidence toward the transparent plate so that the light emitted from the light-emission unit is totally reflected at the interface between the transparent plate and the external atmosphere to obtain the first reflected light, and
a second lens that spreads out a range of the angle of incidence to the transparent plate so that the light emitted from the light-emission unit passes through the transparent plate to obtain the second reflected light.

12. The optical sensor of claim 1, further comprising:
a light collecting lens that collects the first reflected light and the second reflected light into the light-reception unit.

13. The optical sensor of claim 1, wherein
the light-reception unit includes a plurality of light-reception elements arranged side by side in a matrix configuration.
